(19) United States
(12) Patent Application Publication
(10) Pub. No.: US 2026/0177195 A1
(43) Pub. Date: Jun. 25, 2026

(54) TRANSDUCER POLE SYSTEM WITH ADJUSTMENT FEATURES

(71) Applicant: RAILBLAZA LIMITED, Auckland (NZ)

(72) Inventors: Christopher Ross PRATT, Auckland (NZ); Taite SHEPHERD, Auckland (NZ); Mike EDGINGTON, Auckland (NZ)

(73) Assignee: RAILBLAZA LIMITED, Auckland (NZ)

(21) Appl. No.: 19/121,380

(22) PCT Filed: Oct. 18, 2023
(86) PCT No.: PCT/IB2023/060533

§ 371 Date: Apr. 15, 2025

Related U.S. Application Data
(60) Provisional application No. 63/418,431, filed on Oct. 21, 2022.

(51) Int. Cl. F16M 11/20; A01K 85/16; B63B 25/00; F16M 13/02

(52) U.S. Cl. CPC F16M 11/2021; A01K 85/16; B63B 25/002; F16M 13/02

(57) ABSTRACT

A transducer pole extension mount system has a handle that adjustably controls the direction of an underwater transducer. The system includes a handle, an elbow joint connecting the handle to an upper pole, and a T-joint guidably connecting the upper pole to a mounting arm and a lower pole. The mounting arm extends through a pivotable mount base for removably mounting the gunnel extension mount to the gunnel (side rail) of a boat. The T-joint allows rotational adjustment and vertical adjustment of the mounting arm with respect to the upper pole connected to a lower pole at a knuckle joint allowing convenient folding of the lower pole to the upper pole. The lower pole terminates at a transducer bracket supporting a transducer. A directional pointer is provided on the upper pole. In use, manually rotating the handle to adjusts the transducer to change the pointing direction of the transducer.

### CROSS REFERENCE TO RELATED INVENTIONS

This application relates to and claims priority from U.S. Provisional Ser. No. 63/418,431 filed Oct. 21, 2022, the entire contents of which are incorporated herein by reference.

### FIGURE SELECTED FOR PUBLICATION

FIG. 1.

### TECHNICAL FIELD

The present invention is directed to a transducer pole system with adjustment features for use with marine sonar transducers used as fish finders and, more particularly, to a marine transducer gunnel extension mount allowing onboard manual control, an indicia indicator of the pointing direction of a submerged directional transducer usable as a fish finder, and convenient compact storage.

### BACKGROUND

This section of this document introduces information about and/or from the art that may provide context for or be related to the subject matter described herein and/or claimed below. It provides background information to facilitate a better understanding of the various aspects of the technology described below. This is a discussion of “related” art. That such art is related in no way implies that it is also “prior” art. The related art may or may not be prior art. The discussion in this section of this document is to be read in this light, and not as admissions of prior art.

Fish finders include underwater sonar transducers and associated above-water display devices used on fishing boats to detect the presence of fish underwater in the vicinity of the boat or other locus. Most conventional fish finders are omnidirectional allowing them to detect the presence and relative size of objects presumed to be fish but not the direction to the fish from the boat other than in a general sense.

Dedicated directional underwater transducers are available but are not typically used as consumer recreational fish finders because the pointing direction of the transducer is usually fixed with respect to the boat mount limiting fish sensing to one direction from the boat (e.g., in a dedicated direction such as ‘forward’ or in a ‘universal direction’ such as ‘outward’). This is a similar concern where the conventional underwater transducer is used to sense submerged geographic debris, rocks, or other detritus. The physical bracket mounting the directional sonar transducer to the boat typically has to be manually adjusted and re-fixed/re-secured to change the pointing direction of the transducer with respect to the boat, which is clumsy and unduly time consuming to be useful in the ordinary course of dynamic fishing adventures in a river, lake or on the ocean. While motor controlled directional fish finders are commercially available, they are costly, require complex electronic or hydraulic motive structures and are far beyond the price point recreational fishing consumers find suitable.

Regarding the prior art it will be understood that consumer-type sonar transducers are emissive/reflective systems with signal processing systems to provide indicia of the resultant feed on a visual display, commonly used to locate fish or other underwater features or detritus for sporting purposes.

There is, therefore, a continuing need for more functional, effective, and cost effective way to mount and operate directional fish finders.

### ASPECTS AND SUMMARY OF THE INVENTION

The present invention meets at least one of the needs described above through a marine use transducer gunnel extension mount including a manually operated handle that changes the pointing direction of an underwater transducer usable as a fish finder.

According to one alternative aspect of the present invention, the marine transducer gunnel extension mount includes a handle, an elbow joint connecting the handle to an upper pole, and a T-joint connecting the upper pole to a mounting arm and a lower pole. The mounting arm extends through a gunnel mount base for easily and removably mounting the gunnel extension mount to the gunnel (side rail) of the boat. The T-joint allows vertical adjustment of the mounting arm with respect to the upper pole. The upper pole is connected to a lower pole at a knuckle joint allowing convenient folding of the lower pole with respect to the upper pole. The lower pole terminates at a transducer bracket, which removably supports a directional transducer. The transducer bracket may be a separate structure, may be physically integrated with the lower pole, or may be physically integrated with the directional transducer as a matter of design choice. A cable operatively connects the directional transducer to a display device in the same manner as a conventional fish finder. The user manually rotates the handle generally parallel to the gunnel to rotate the directional transducer to change the pointing direction of the directional transducer.

According to another alternative aspect of the present invention, there is provided a transducer gunnel extension mount, comprising: a manually operated handle that controls an orientation of a transducer mount bracket, an elbow joint connects the handle to an upper pole that has a first extrusion profile, a folding and locking knuckle joint connects the upper pole to a lower pole, the folding and locking knuckle joint forms a folding pivot between respective the upper and lower poles, the lower pole terminates at the transducer mount bracket that removably supports a directional transducer, a T-joint connects the upper pole to a mounting arm extending through a gunnel mount base adjustably mounted to a gunnel of a vessel, the mounting arm has a second extrusion profile with a plurality of receiving recesses extending along an outer surface, the plurality of receiving recesses include at least one use position recess and one storage position recess, the mounting arm is removably mounted in the gunnel mount base, the first extrusion profile is selected from of an extrusion profile different from the second extrusion profile and an extrusion profile the same as the second extrusion profile, the gunnel mount base has a fixed bottom portion and an adaptive top portion, the adaptive top portion allowing a rotational positioning of the mounting arm and the T-joint between a use position and a storage position by engaging respective use position recess and storage position recess, a direction indicator adjustably fixed as a collar to the upper pole proximate the T-joint enables a pivotal rotation of the upper pole relative to the T-joint during an adjustment of the handle thereof while preventing a through-sliding of the upper pole, the T-joint, the mounting arm, and the gunnel mount operably and removably mount the upper pole and the lower pole to the gunnel of the vessel, and wherein a rotation of the handle relative to the gunnel rotates the direction indicator and the transducer bracket to orient an operating direction of a directional transducer supported by the transducer mount bracket.

According to another alternative aspect of the present invention, there is a provided a transducer gunnel extension mount further comprising: an underwater transducer connected to the transducer bracket.

According to another alternative aspect of the present invention, there is a provided a transducer gunnel extension mount wherein: the upper and lower poles are adaptively adjustable relative to the T-joint and the direction indicator, whereby a depth adjustment of the transducer gunnel extension mount is achieved while maintaining a visual indicator of the alignment of the directional transducer mount.

According to another alternative aspect of the present invention, there is a provided a transducer gunnel extension mount wherein: one or more of the upper pole, the lower pole, and the mounting arm are formed from metal extrusions.

According to another alternative aspect of the present invention, there is a provided a transducer gunnel extension mount wherein: one or more of the upper pole, lower pole, and mounting arm are one of galvanized, electroplated, painted, and plastic coated to inhibit a corrosion.

According to another alternative aspect of the present invention, there is a provided a transducer gunnel extension mount wherein: an end portion of the handle is covered with a plastic grip

According to another alternative aspect of the present invention, there is a provided a transducer gunnel extension mount wherein: one or more of the elbow joint, T-joint, gunnel mount base, knuckle joint, and transducer bracket are fabricated from a plastic material or a blend of plastic materials.

According to another alternative aspect of the present invention, there is a provided a transducer gunnel extension mount wherein: one or more of the handle, upper pole, lower pole, and mounting arm are fabricated in whole or in part from a plastic material or blend.

According to another alternative aspect of the present invention, there is a provided a transducer gunnel extension mount, further comprising: an indexing release member operably engaging the adaptive top portion of the gunnel mount, the indexing release member urgingly received in the gunnel mount and shaped to engage one of the plurality of receiving recess in the second extrusion profile of the mounting arm, and the indexing release member enabling a rotation and a removal of the mounting arm from the gunnel mount.

According to another alternative aspect of the present invention, there is a provided a transducer gunnel extension mount, further comprising: at least one manual release locking tab in the gunnel mount base, the at least one manual release locking tab extending between the adaptive top portion and the fixed bottom portion of the gunnel mount, and the at least one manual release locking tab operable between and an adjustment position allowing relative rotation between the adaptive top portion and the fixed bottom portion and a locked position fixing the relative position of the adaptive top portion to the fixed bottom portion.

It will be understood that specific embodiments may include a variety of features and options in different combinations, as may be desired by different users. Practicing the invention does not require utilization of all, or any particular combination, of these specific features or options. The specific techniques and structures for implementing particular embodiments of the invention and accomplishing the associated advantages will become apparent from the following detailed description of the embodiments and the appended drawings and claims.

The above presents a simplified summary of the invention as clamed below in order to provide a basic understanding of some aspects of the invention. This summary is not an exhaustive overview of the invention. It is not intended to identify key or critical elements of the disclosure or to delineate the scope of the invention. Its sole purpose is to present some concepts in a simplified form as a prelude to the following more detailed description, appended drawings, and claims.

The above and other aspects, features and advantages of the present invention will become apparent from the following description read in conjunction with the accompanying drawings, in which like reference numerals designate the same elements.

### BRIEF DESCRIPTION OF THE FIGURES

Illustrative embodiments of the subject matter claimed below will now be disclosed. In the interest of clarity, not all features of each actual implementation are described in this specification. It will be appreciated that in the development of any such actual embodiment, numerous implementation-specific decisions must be made to achieve the specific goals, such as compliance with structure limiting constraints, which will vary from one implementation to another. Moreover, it will be appreciated that, having studied and appreciated the enclosed disclosure that such modifications, even if complex and time-consuming, would be a routine undertaking for those of ordinary skill in the art after having the benefit of this disclosure.

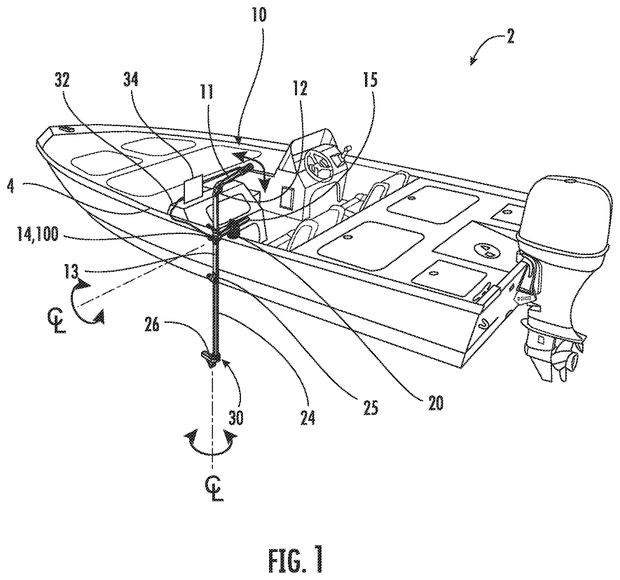

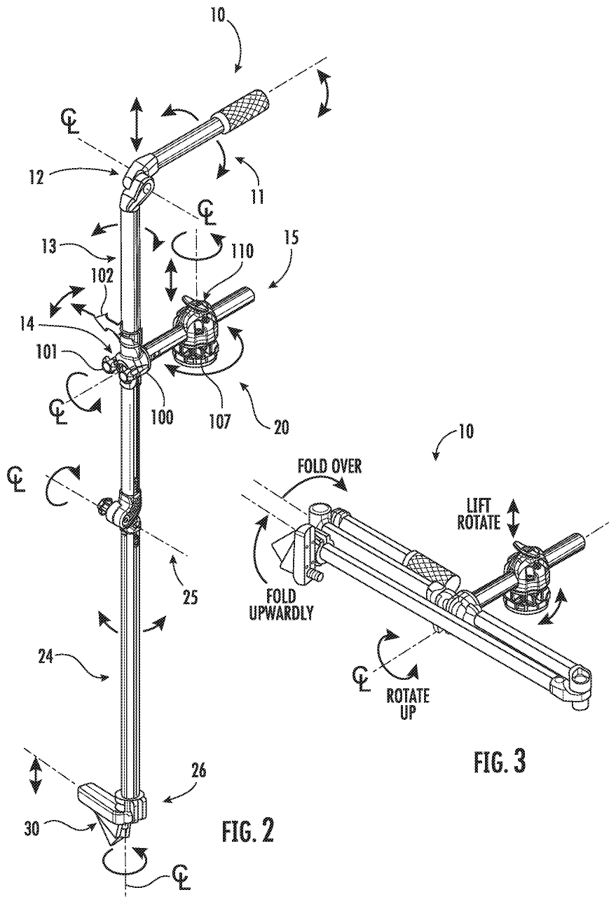

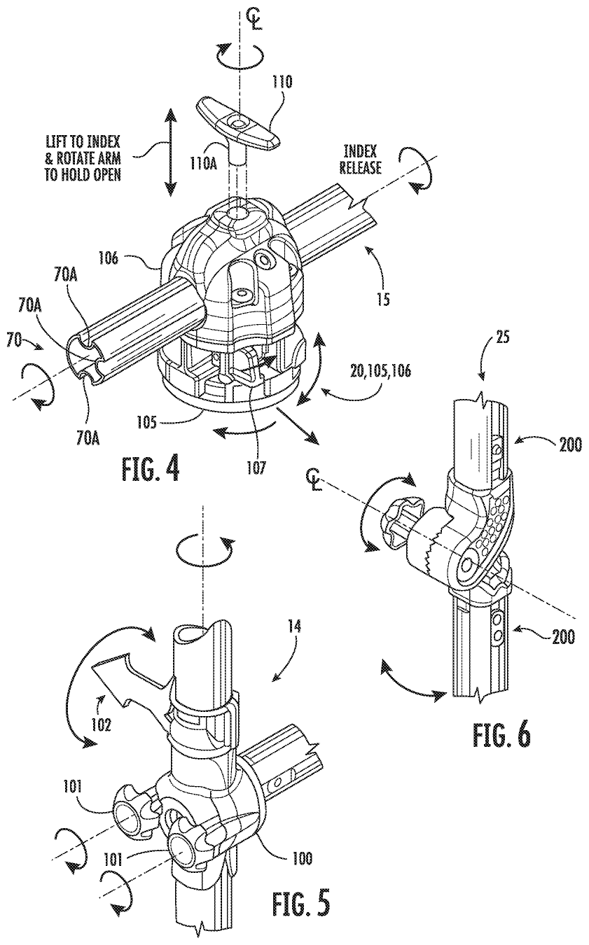

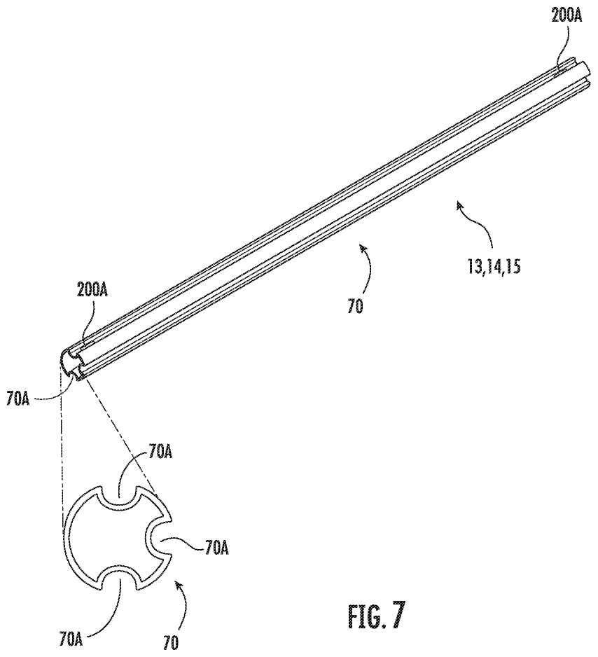

FIG. 1 is a conceptual perspective illustration showing a representative example of a transducer pole extension mount according to the present invention attached to a fishing boat.

FIG. 2 is a conceptual perspective illustration of the transducer pole extension mount in a deployed (unfolded) configuration.

FIG. 3 is a conceptual perspective illustration of the transducer pole gunnel extension mount in a stowed (folded) configuration.

FIG. 4 is a perspective partial view of a gunnel mount base of the transducer pole gunnel extension mount, illustrating adjustment features.

FIG. 5 is a perspective partial view of a T-joint of the transducer gunnel extension mount illustrating alignment and adjustment features.

FIG. 6 is a perspective partial view of a knuckle joint of the transducer gunnel extension mount illustrating adjustment features.

FIG. 7 is a perspective view of a mounting arm of the transducer gunnel extension mount including details showing the extrusion profile and locking detents and slide adjustments.

While the invention is susceptible to various modifications and alternative forms, the drawings illustrate representative embodiments of the invention by way of example. It should be understood, however, that the description of specific examples is not intended to limit the invention to the particular forms disclosed, but on the contrary, the intention covers all modifications, equivalents, and alternatives falling within the spirit and scope of the invention as defined by the appended claims.

### DESCRIPTION OF ILLUSTRATIVE EMBODIMENTS

Reference will now be made in detail to selected embodiments of the invention. Wherever possible, same or similar reference numerals are used in the drawings and the description to refer to the same or like parts or steps. The drawings are in simplified form and are not to precise scale. The word ‘couple’ or ‘secure’ and similar terms do not necessarily denote direct and immediate connections, but also include connections through intermediate elements or devices. For purposes of convenience and clarity only, directional (up/down, rotate/flex etc.) or motional (forward/back, etc.) terms may be used with respect to the drawings. These and similar directional terms should not be construed to limit the scope in any manner. It will also be understood that other embodiments may be utilized without departing from the scope of the present invention, and that the detailed description is not to be taken in a limiting sense, and that elements may be differently positioned, or otherwise noted as in the appended claims without requirements of the written description being required thereto.

Various operations may be described as multiple discrete operations in turn, in a manner that may be helpful in understanding embodiments of the present invention; however, the order of description should not be construed to imply that these operations are order dependent.

It will be recognized that the description herein for a transducer pole system with adjustment features may be alternatively referred to as a marine transducer gunnel extension mount system without departing from the scope and spirit of the present invention.

Adaptive and optional embodiments of the present invention include a transducer gunnel extension mount including a manually operated handle that changes the pointing direction of an underwater transducer usable as a fish finder. FIGS. 1-7 illustrate a fishing boat 2 having a gunnel 4 carrying a representative example of the marine transducer extension mount system 10, which includes a handle 11, an elbow joint 12 connecting the handle 11 to an upper pole 13, and a T-joint 14 connecting the upper pole 13 to a mounting arm 15 and a lower pole 24. The mounting arm 15 extends through a gunnel mount base 20 for easily and removably mounting and adjusting the gunnel extension mount system 10 to the gunnel (side rail) of the boat 2. The T-joint 14 allows vertical adjustment of the upper pole 13 with respect to the mounting arm 15 and the gunnel mount base 20 as will be explained. The upper pole 13 is connected to a lower pole 24 at a knuckle joint 25 having a pivot axis (as shown) and a locking-adjustment screw (as shown) allowing convenient folding of the lower pole 24 with respect to the upper pole 13 during a storage use. The lower pole 24 terminates at a transducer bracket 26, which removably supports a conventional directional transducer 30 such as a commercially available transducer and display combination as is known in the art. It will be recognized that directional transducer 30 is preferably removably fixed at the bottom of lower pole 24 in a specific direction which aligns with directional indicator or direction indicia 102 (FIGS. 2 and 5) fixed on upper pole 13 positioned (above water level) above T-joint 14 and a depth control clamp 100 (see FIGS. 2 and 5) that is operative with height-sliding-adjustment as will be discussed. The transducer bracket 26 may be a separate structure, may be physically integrated with the lower pole 24, or may be physically integrated with the directional transducer mount 30 as a matter of design choice. A connecting cable 32 (FIG. 1) operatively connects the directional transducer 30 to a display device 34 in the same manner as a conventional transducer/fish finder. During an operative use of extension mount system 10, the user manually rotates the handle 11 generally parallel to the gunnel to rotate the directional transducer 30 to change the pointing direction of the directional transducer.

The directional transducer 30, cable 32, and display device 34 may be conventional and may not be part of claimed embodiments of the invention. The upper and lower poles 13, 24 rotate relative to knuckle joint 25, as will be discussed and nest proximate to each other (FIG. 3). The upper and lower poles 13, 24 are relatively adjustable though T-joint 14 to raise and lower transducer bracket 26 relative to gunnel 4 and change the depth of the transducer bracket 26 with respect to the gunnel mount base 20. The upper and lower poles 13, 24 may be extrusions of aluminum or another suitable metal, such as steel or a steel alloy in any suitable shape. In the event an oxidizable metal (Steel, Iron, Aluminum etc.) is utilized for the poles, the surface may be galvanized, electroplated, painted, rubberized or treated with another protectant to inhibit corrosion. The end portion of the handle 11 is typically covered with a plastic grip (shown). The elbow joint 12, T-joint 14, gunnel mount base 20, knuckle joint 25, and transducer bracket 26 are preferably fabricated from a plastic material or blend, such as carbon and plastic materials and blends, such as polycarbonate (PC), Acrylonitrile Butadiene Styrene (ABS), high density polyethylene (HDPE), nylon, glass-filled nylon, graphene, fiberglass, and the like. As another design option, one or more of the handle 11 and poles 13, 24 may also be fabricated in whole or in part from this type of plastic material or blend without departing from the scope and spirit of the present invention.

It will be further understood, as shown that there is a height or depth control clamp 100 on T-Joint 14 is adjustable so that sides of opposing gripping members of depth control clamp 100 adapt with adjustment tightening screws 101, 101 allow the gripping and sliding release of upper pole 13 to set a depth relative to gunnel mount base 20 and rotating pivot member 20A. Additionally, there is provided a direction indicia or direction indicator 102 (shown here as an arrow but not limited there to) which is removably and slidably affixed to upper pole 13 above depth control clamp 100 but positioned relatively to the direction alignment of transducer bracket 26 and directional transducer mount 30, so that, during use, a user may readily loosen screws 101, 101 slightly, and readily pivot upper pole 13 and lower pole 24 and clearly visually appreciate (via indicator 102) the direction of a sonar transducer 30 mounted on transducer bracket 26. As a result, a user may readily and easily adjust and determine the direction of use (relative to arrow indicia 102) and adjust handle 11 accordingly to direct the sonar signal in a desired direction. If a user has a preferred orientation of transducer bracket 26, then tightening screws 101, 101 may be fully tightened to fix the desired orientation.

Additionally, it will be further understood that gunnel mount base 20 contains two main components a lower fixed based member 105 which is fixably mounted to the vessel location, shown at an edge or on gunnel 4, and an upper adjustable base member 106. Upper adjustable base member 106 is positioned releasably and pivotably relative to the lower fixed base member 105 with a series of finger control lock tabs 107, 107 which control locking threaded members that extend from upper adjustable base member 106 to lower fixed base member 105 and lock mount base 20 in relative pivot position between uses. In this manner it may be appreciated that when compacted in a storage position (FIG. 3) a complete rotation about a centerline of mount base 20 is possible to pivot the entire gunnel extension mount system 10 onboard boat 2 for safe storage. In this manner it may be also appreciated that when small amounts of relative pivot adjustment are needed this may be achieved by loosening and tightening finger control lock tabs 107, 107.

Further, as noted there an indexing release member 110 is provided which is urgeably liftable from upper adjustable base member 106 under an urging force and maintains a projecting member 110A (FIG. 4) that is received within respective indexing grooves 70A, 70A, 70A, on extrusion profile 70 (see FIG. 7). In this manner, it will be understood by those of skill in the art having studied the present disclosure, that upon lifting index release member 110, extrusion profile 70 (for example, mounting arm 15 in FIG. 2) may rotate ninety (90) degrees in either direction relative to fixed base 105 and so be positioned in rotated location as shown in FIG. 3 for compact storage and that upon release projecting member 110A is urgeably returned to upper adjustable base member 106 and engages with a respective indexing groove 70A. In this manner it will be appreciated having studied the full disclosure herein that rotation may be achieved for storage and safety (See FIG. 3) so that shallow water, boat-trailer mounting, or storage or other causation will not damage the transducer gunnel extension mount system 10.

Those of skill in this art, having full studied and appreciated the disclosure herein will recognize that by further lifting indexing release member 100 allows not only rotational adjustment of mounting arm 15 (FIG. 2) or illustrated as extension profile 70 (FIG. 7), but also the removal (not shown) of mounting arm 15 from within mount base 20 for separate storage and maintenance or assembly. Following such storage or maintenance or assembly then reassembly is easily achieved by slidably returning mounting arm 15 to mount base 20. In this way safe storage (theft prevention) and easy modification and maintenance are additionally realized.

Those of skill in the art having appreciated the respective elements of the disclosure herein and the respective operations herein will recognize that each component, feature, and structure may be accomplished in a several and more than one shape and form. For a non-limiting example, the T-joint 14 is formed as shown (FIG. 2) but may be formed differently using different geometry with less smooth or more boxy construction or lever locks instead of threaded knobs, while still functioning in a variety of shapes as a t-joint for joining the mounting arm 15 to the respective upper pole 13. Similarly, the mounting arm 15 is shown (FIGS. 4 and 7) having a plurality of positioning indexing grooves 70A, etc. may be formed in different forms and shapes while accomplishing the same use. For example, each of the indexing groves may be v-shaped, dual-v-shaped, rectangular-shaped, or a series of indexing holes (openings) while still allowing the indexing release member 110 to engage a respective indexing grove and prevent a pivot of mounting arm relative to upper base 106. Still further, those of skill in this art having appreciated the disclosure herein will recognize that upper base 106 and gunnel mount base 20 may be in any suitable shape effective to accommodate the operations herein. For example, instead of the dome-type-shape of mount base 20 noted herein, an angular shape, cylindrical shape, a geometric shape, a fully smooth shape, or a modification of any other shape may be provided as long as a lower portion 105 may be fixed and an upper portion 106 pivot while receiving the mounting arm 15 in an adaptive and adjustable manner. As a result, it will be readily apparent to those of skill in the art having appreciated the scope and spirit of the invention, that a wide variety of shapes and forms for the disclosed elements may be used while maintaining the function of the present invention.

This disclosure sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components may be combined to achieve a particular functionality can be seen as “associated with” each other such that the desired functionality is achieved, irrespective of architectures or intermediate components. Likewise, any two components so associated can also be viewed as being “connected”, or “coupled”, to each other to achieve the desired functionality, and any two components capable of being so associated can also be viewed as being “functionally connected” to each other to achieve the desired functionality. Specific examples of functional connection include but are not limited to physical connections and/or physically interacting components and/or wirelessly communicating and/or wirelessly interacting components and/or logically interacting and/or logically interacting components.

It will be appreciated that layers, features, elements, etc., depicted herein are illustrated with particular dimensions relative to one another, such as structural dimensions or orientations, for example, for purposes of simplicity and ease of understanding and that actual dimensions of the same differ substantially from that illustrated herein, in some embodiments. Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application and the appended claims are generally to be construed to mean “one or more” unless specified otherwise or clear from context to be directed to a singular form. Also, at least one of A and B and/or the like generally means A or B or both A and B. Furthermore, to the extent that “includes”, “having”, “has”, “with”, or variants thereof are used, such terms are intended to be inclusive in a manner similar to the term “comprising”. Also, unless specified otherwise, “first,” “second,” or the like are not intended to imply a temporal aspect, a spatial aspect, an ordering, etc. Rather, such terms are merely used as identifiers, names, etc. for features, elements, systems, or components, or items, etc. For example, a first element and a second element generally correspond to element A and element B or two different or two identical elements or the same element.

While particular aspects of the present subject matter have been shown and described in detail, it will be apparent to those skilled in the art that, based upon the teachings of this disclosure, changes and modifications may be made without departing from the subject matter described in this disclosure and its broader aspects and, therefore, the appended claims are to encompass within their scope all such changes and modifications as are within the true spirit and scope of the subject matter described in this disclosure. Although particular embodiments of this disclosure have been illustrated, it is apparent that various modifications and embodiments of the disclosure may be made by those skilled in the art without departing from the scope and spirit of the disclosure. Accordingly, the scope of the disclosure should be limited only by the claims appended hereto.

The invention claimed is:

1. A transducer gunnel extension mount, comprising:
a manually operated handle that controls an orientation of a transducer mount bracket;
an elbow joint connects the handle to an upper pole that has a first extrusion profile;
a folding and locking knuckle joint connects the upper pole to a lower pole;
the folding and locking knuckle joint forms a folding pivot between respective said upper and lower poles;
the lower pole terminates at said transducer mount bracket that removably supports a directional transducer;
a T-joint connects the upper pole to a mounting arm extending through a gunnel mount base adjustably mounted to a gunnel of a vessel;
said mounting arm has a second extrusion profile with a plurality of receiving recesses extending along an outer surface, said plurality of receiving recesses include at least one use position recess and one storage position recess;
said mounting arm is removably mounted in said gunnel mount base;
the first extrusion profile is selected from of an extrusion profile different from the second extrusion profile and an extrusion profile the same as the second extrusion profile;
the gunnel mount base has a fixed bottom portion and an adaptive top portion;
said adaptive top portion allowing a rotational positioning of said mounting arm and said T-joint between a use position and a storage position by engaging respective use position recess and storage position recess;
a direction indicator adjustably fixed as a collar to the upper pole proximate the T-joint enables a pivotal rotation of said upper pole relative to said T-joint during an adjustment of said handle thereof while preventing a through-sliding of said upper pole;
said T-joint, said mounting arm, and said gunnel mount operably and removably mount said upper pole and said lower pole to said gunnel of said vessel; and
wherein a rotation of the handle relative to said gunnel rotates said direction indicator and said transducer bracket to orient an operating direction of a directional transducer supported by said transducer mount bracket.

2. The transducer gunnel extension mount of claim 1, further comprising:
an underwater transducer connected to the transducer bracket.

3. The transducer gunnel extension mount of claim 1, wherein:
said upper pole and said lower pole are adaptively adjustable relative to said T-joint and said direction indicator;
whereby a depth adjustment of said transducer gunnel extension mount is achieved while maintaining a visual indicator of the alignment of said directional transducer mount.

4. The transducer gunnel extension mount of claim 1, wherein:
one or more of said upper pole, said lower pole, and said mounting arm are formed from metal extrusions.

5. The transducer gunnel extension mount of claim 1, wherein:
one or more of said upper pole, said lower pole, and said mounting arm are one of galvanized, electroplated, painted, and plastic coated to inhibit a corrosion.

6. The transducer gunnel extension mount of claim 1, wherein:
an end portion of the handle is covered with a plastic grip.

7. The transducer gunnel extension mount of claim 1, wherein:
one or more of said elbow joint, said T-joint, said gunnel mount base, said knuckle joint, and said transducer bracket are fabricated from a plastic material or a blend of plastic materials.

8. The transducer gunnel extension mount of claim 1, wherein:
one or more of said handle, said upper pole, said lower pole, and said mounting arm are fabricated in whole or in part from a plastic material or blend.

9. The transducer gunnel extension mount of claim 1, further comprising:
an indexing release member operably engaging said adaptive top portion of said gunnel mount;
said indexing release member urgingly received in said gunnel mount and shaped to engage one of said plurality of receiving recess in said second extrusion profile of said mounting arm; and
said indexing release member enabling a rotation and a removal of said mounting arm from said gunnel mount.

10. The transducer gunnel extension mount of claim 9, further comprising:
at least one manual release locking tab in said gunnel mount base;
said at least one manual release locking tab extending between said adaptive top portion and said fixed bottom portion of said gunnel mount; and
said at least one manual release locking tab operable between and an adjustment position allowing relative rotation between said adaptive top portion and said fixed bottom portion and a locked position fixing the relative position of said adaptive top portion to said fixed bottom portion.
